(19) United States
(12) Patent Application Publication
(10) Pub. No.: US 2024/0403333 A1
(43) Pub. Date: Dec. 5, 2024

(54) SYSTEM AND METHOD FOR ELECTRONIC PROCESSING OF DATA ITEMS FOR ENHANCED SEARCH

(71) Applicant: Innoplexus AG, Eschborn (DE)

(72) Inventor: Nils Bertschinger, Frankfurt am Main (DE)

(73) Assignee: Innoplexus AG, Eschborn (DE)

(21) Appl. No.: 18/326,209

(22) Filed: May 31, 2023

(51) Int. Cl. G06F 16/28

(52) U.S. Cl. CPC G06F 16/287

(57) ABSTRACT

A method for electronic processing of data items for enhanced search that includes receiving, a plurality of data items from a defined database, pairing of the plurality of data items based on one or more criterions, determining a regression score for each pair of data items associated with a corresponding pair of data items performing a hierarchical clustering of the plurality of data items and constructing a visual representation comprising hierarchical relationship among the plurality of data items clustered based on the hierarchical clustering and segregating the visual representation into a plurality of clusters based on a predetermined threshold and probabilistic similarity information. Moreover, each cluster of the plurality of clusters includes a group of data items that are similar to each other with respect to a defined number of parameters to allow retrieval during a search against one or more parameters from the defined number of parameters.

### FIELD OF TECHNOLOGY

The present disclosure relates generally to a data processing, and more specifically, to a method and a system for the electronic processing of data items for enhanced search, such as a hierarchical clustering of the data items based on the probabilistic similarity information.

### BACKGROUND

Hierarchical clustering is a technique that is used for data analysis to group similar data, such as text documents, videos, images, and the like together based on the similarities or distance between pairs of objects. Typically, hierarchical clustering algorithms that can handle probabilistic similarity scores, such as the probabilistic similarity scores between two documents of the same topic that is used to perform hierarchical clustering are used. The clustering algorithms require proper metric distances or other similarity scores to assign objects to clusters or compute cluster centers. However, such clustering algorithms fail to produce meaningful or optimal solutions when using probabilistic similarity scores in combination with metric or weighted linkage functions.

Conventional hierarchical clustering methods are based on the probabilistic similarity scores and use ad-hoc algorithms that include the correction of transitivity violations of the probabilistic similarity scores. Thereafter, the conventional hierarchical clustering methods include the formation of clusters, such as by assigning objects incrementally. However, such conventional hierarchical clustering methods result in inaccurate clustering due to the lack of a meaningful and formal objective function. As a result, the resulted clusters fail to reflect the probabilistic nature of the similarity information.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method and a method for the electronic processing of data items for enhanced search. The present disclosure seeks to provide a solution to the existing problem to achieve efficient and accurate clustering of data items, such as documents, images, videos, and the like with an accurate, meaningful, and formal objective function. An aim of the present disclosure is to provide a solution that overcomes at least partially the problems encountered in the prior art and provide an improved method and an improved system for electronic processing of the data items for enhanced search in a way such that the hierarchical clustering of the data items is performed by utilizing the probabilistic similarity information in a systematic and principled fashion.

In one aspect, the present disclosure provides a method for electronic processing of data items for enhanced search, data item the method comprising:
receiving, by a processor, a plurality of data items from a defined database;
pairing, by the processor, the plurality of data items based on one or more criterions;
determining, by the processor, a regression score for each pair of data items based on a probability score associated with a corresponding pair of data items;
performing, by the processor, a hierarchical clustering of the plurality of data items based on the determined regression score for each pair of data items;
constructing, by the processor, a visual representation comprising a hierarchical relationship among the plurality of data items clustered based on the hierarchical clustering; and
segregating, by the processor, the visual representation into a plurality of clusters based on a predetermined threshold and probabilistic similarity information, wherein each cluster of the plurality of clusters comprises a group of data items that are similar to each other with respect to a defined number of parameters to allow retrieval during a search against one or more parameters from the defined number of parameters.

The method of the present disclosure provides an efficient, systematic, accurate and principled hierarchical clustering of the plurality of data items, such as based on the probabilistic similarity information, such as by optimizing a probabilistic objective function. For example, clustering the plurality of data items by using an average linkage hierarchical clustering. The method uses a regression score and hierarchical clustering algorithm that is used to identify similarities between the plurality of data items and further group the similar data items together, resulting in a more organized and structured data set (i.e., a cluster of data items). Furthermore, the identification of the similarities between the plurality of data items is performed through a trained binary classifier that is trained to identify the negative as well as positive results. In addition, the method is used for constructing the visual representation that depicts hierarchical relationships between the plurality of data items. Moreover, the method is used for segregating the visual representation into clusters based on a predetermined threshold and probabilistic similarity information to retrieve the one or more data items based on specific parameters or characteristics in a reduced processing time and effort that can be required to manually search through large data sets. As a result, the method is used for providing an intuitive way to navigate, retrieve, analyze, and interpret the one or more similar data items. Moreover, the method is used for processing and organizing large amounts of data in order to search for the relevant information quickly and easily.

In another aspect, the present disclosure provides a system for electronic processing of data items for enhanced search, the system comprising:
a processor configured to:
   receive a plurality of data items from a defined database;
   pair the plurality of data items based on one or more criterions;
   determine a regression score for each pair of data items based on a probability score associated with a corresponding pair of data items;
   perform a hierarchical clustering of the plurality of data items based on the determined regression score for each pair of data items;
   construct a visual representation comprising hierarchical relationship among the plurality of data items clustered based on the hierarchical clustering; and
   segregate the visual representation into a plurality of clusters based on a predetermined threshold and probabilistic similarity information, wherein each cluster of the plurality of clusters comprises a group of data items that are similar to each other with respect to a defined number of parameters to allow retrieval during a search against one or more parameters from the defined number of parameters.

The system achieves all the advantages and technical effects of the method of the present disclosure.

It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a system for electronic processing of data items for enhanced search, in accordance with an embodiment of the present disclosure;

FIG. 2 is a block diagram that depicts a system for electronic processing of data items for enhanced search, in accordance with an embodiment of the present disclosure;

FIG. 3 is a flowchart of a method for processing a plurality of data items for enhanced search, in accordance with an embodiment of the present disclosure;

FIG. 4 is an exemplary illustration that depicts segregation of a visual representation in order to obtain a plurality of clusters, in accordance with an embodiment of the present disclosure; and

FIG. 5 is a flowchart of a method for electronic processing of data items for enhanced search, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

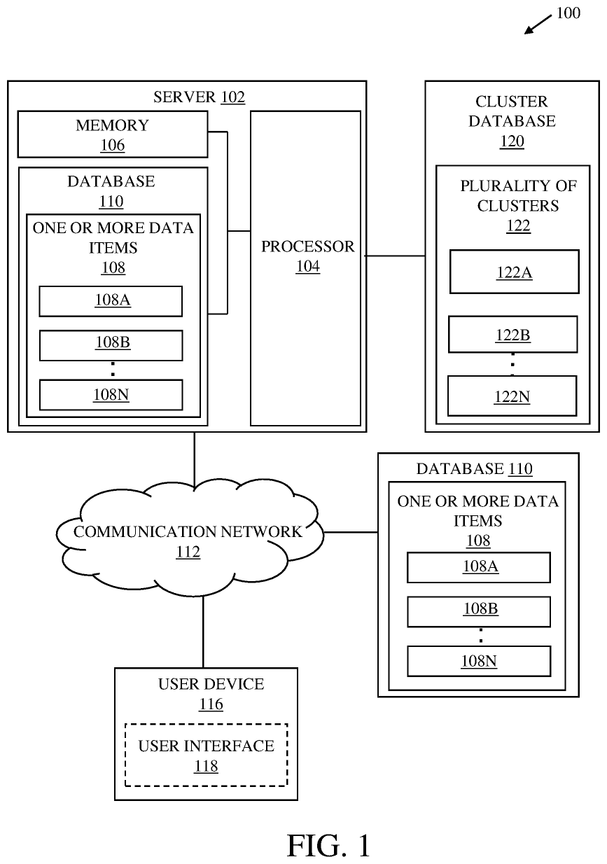

FIG. 1 is a block diagram of a system for electronic processing of data items for enhanced search, in accordance with an embodiment of the present disclosure. With reference to FIG. 1, there is shown a block diagram of a system 100. The system 100 includes a server 102, a processor 104, and a memory 106. The processor 104 is communicatively coupled with the memory 106. The system 100 may be used to electronically process the plurality of data items 108, such as a first data item 108A, a second data item 108B, up to nth data item 108N, such as the hierarchical classification of the plurality of data items 108 for the enhanced search.

In an implementation, the processor 104 and the memory 106 may be implemented on the same server, such as the server 102. In some implementations, the system 100 further includes a defined database, such as a database 110 communicatively coupled with the server 102 via a communication network 112. The database 110 includes the plurality of data items 108, such as the first data item 108A, the second data item 108B, and up to the nth data item 108N. In some implementations, the plurality of data items 108 may be retrieved from the database 110, as per requirement. In some implementations, the plurality of data items 108 may be stored in the same server, such as the server 102. In some other implementations, the plurality of data items 108, such as a first data item 108A, a second data item 108B, up to nth data item 108N may be stored outside the server 102, as shown in FIG. 1 in the database 110. Moreover, the server 102 may be communicatively coupled to a plurality of user devices, such as a user device 116, via the communication network 112. The user device 116 includes a user interface 118.

The present disclosure provides the system 100 that is configured to electronically process the data items for enhanced search, such as through unsupervised clustering of the plurality of the data items 108. The plurality of data items 108, such as the first data item 108A, the second data item 108B, up to the nth data item 108N may include but is not limited to, a text document, patient charts, and lab reports, legal documents, contracts and court transcripts, business documents, such as invoices and purchase orders, financial documents, bank statements and tax returns, technical manuals, instructional documents, images, videos, and the like.

The server 102 includes suitable logic, circuitry, interfaces, and code that may be configured to communicate with the user device 116 via the communication network 112. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 is configured to store the instructions executable by the processor 104. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory. Moreover, the database 110 is configured to store the plurality of data items 108. For example, the database 110 is configured to store the first data item 108A. Similarly, the database 110 is configured to store the second data item 108B up to the nth data item 108N.

The communication network 112 includes a medium (e.g., a communication channel) through which the user device 116 communicates with the server 102. The communication network 112 may be a wired or wireless communication network. Examples of the communication network 112 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The user device 116 refers to an electronic computing device operated by a user. The user device 116 may be configured to obtain a user input of one or more words in a search portal or a search engine rendered over the user interface 118 and communicate the user input to the server 102. The server 102 may then be configured to retrieve the group of similar data items. Examples of the user device 116 may include but are not limited to a mobile device, a smartphone, a desktop computer, a laptop computer, a Chromebook, a tablet computer, a robotic device, or other user devices. Moreover, the cluster database 120 refers to a database that has a well-defined schema or structure that may not have inconsistencies, errors, and redundancies in the data so that the analysis of the data becomes easy. Moreover, the cluster database 120 includes a plurality of clusters 122, such as the first cluster 122A, the second cluster 122B, up to the nth cluster 122N based on the segregated visual representation.

It should be understood by one of the ordinary skills in the art that the operations of the system 100 are explained by using the first data item 108A and the second data item 108B. However, the operation of the system 100 is equally applicable for the plurality of data items 108.

In operation, the processor 104 is configured to receive the plurality of data items 108 from the defined database. For example, the processor 104 is configured to receive the first data item 108A from the database 110. Similarly, the processor 104 is configured to receive the second data item 108B from the database 110. Furthermore, the processor 104 is configured to pair the plurality of data items 108. In an implementation, the processor 104 is configured to pair the plurality of data items 108 randomly. In another implementation, the processor 104 is configured to pair the plurality of data items 108 by applying certain parameters, such as the plurality of data items 108 that are stored in the same folder in the database 110 or any other such parameters without affecting the scope of the present disclosure. For example, the processor 104 is configured to pair the first data item 108A and the second data item 108B together. As a result, the pairs of the plurality of data items 108 are formed to further determine the similarity or the dissimilarity between the formed pairs of the data items. Furthermore, the processor 104 is configured to determine a regression score for each pair of data items based on a corresponding probability score associated with a corresponding pair of data items. The regression score refers to a statistical score that is used to measure the similarity between the pairs of data items. Moreover, the regression score is determined by calculating the log-odds ratio and further averaging the log-odds ratio across each pair of the data items. In an implementation, in order to determine the regression score for each pair of data items based on the probability associated with the corresponding pair of data items, the processor 104 is configured to determine a log-odds ratio for each pair of the data items and average the log-odds ratio across each pair of the data items. Moreover, the log-odds ratio for each pair of documents is defined as a natural logarithm of a ratio between the log-odds of the corresponding pair of documents being similar or dissimilar. In another implementation, the processor 104 is configured to perform the hierarchical clustering of the plurality of data items 108 based on the determined regression score by merging two or more pairs of documents with one another when the average log-odds ratio of the corresponding pairs of documents is less than the predetermined threshold. Moreover, the processor 104 is configured to determine a probability score for each pair of documents by using a binary classifier. In accordance with an embodiment, the processor 104 is further configured to train a binary classifier on imbalanced training data to determine the probability score for each pair of data items. The binary classifier corresponds to a classifier that is trained to predict if the plurality of data items 108 belong to the same cluster or not, such as by categorizing the one or more pairs of the data items as similar or dissimilar based on the probability score. Moreover, the imbalanced training data includes an uneven distribution of similar and dissimilar pairs of example data items. The uneven distribution of the similar and dissimilar pairs of example documents refers to an uneven number of positive and negative pairs of the example data items. However, the negative pairs denote the dissimilar pairs of the example documents and the positive pairs denote the similar pairs of the example data items. As a result, the binary classifier is trained to determine the similarity and dissimilarity between the pairs of the one or more data items that are further used to group the similar data items from the plurality of data items 108 together.

Furthermore, the processor 104 is configured to perform a hierarchical clustering of the plurality of data items 108 based on the determined regression score for each pair of the data items. In other words, the processor 104 is configured to perform the hierarchical clustering of the plurality of data items 108, such as the first data item 108A, the second data item 108B, up to the nth data item 108N based on the similarity between each of the data item from the plurality of the data items 108. For example, if the first data item 108A and the second data item 108B are similar, then, in that case, the first data item 108A and the second data item 108B are clustered together. Similarly, the data items that are similar to each other are clustered together. In accordance with an embodiment, the processor 104 is configured to perform the hierarchical clustering using average linkage clustering in order to perform the hierarchical clustering of the plurality of data items 108 based on the determined regression score. Moreover, the average linkage clustering is used to group the similar data items from the plurality of data items 108 together based on similarities between all pairs of the data items in each of the clusters from the plurality of clusters 122. As a result, the average linkage clustering with regression score are used to identify patterns and hierarchical relationships in the plurality of data items 108, which can be further used for enhanced processing of data, such as data analysis, pattern recognition, and machine learning. In an implementation, the processor 104 is configured to perform the hierarchical clustering of the plurality of data items 108 based on the determined regression score that include the merging of two or more pairs of data items with one another when the average log-odds ratio of the corresponding pairs of data items is less than the predetermined threshold, such as by average linkage clustering. Thus, the system 100 allows an efficient and accurate classification of data items from the plurality of data items 108, such as based on the similarities between the data items from the plurality of data items 108.

Furthermore, the processor 104 is configured to construct a visual representation including a hierarchical relationship among the plurality of data items 108 that are clustered based on the hierarchical clustering. Moreover, the hierarchical relationship refers to a relationship between the plurality of the data items 108, which is represented through a hierarchical or tree-like structure. In an example, the processor 104 is configured to construct a dendrogram that includes the hierarchical relationship among the plurality of data items 108 that are clustered based on the hierarchical clustering. However, another visual representation may be constructed, which includes the hierarchical relationship among the plurality of data items 108 that are clustered based on the hierarchical clustering without affecting the scope of the present disclosure. Furthermore, the processor 104 is configured to segregate the visual representation into the plurality of clusters 122 based on a predetermined threshold and probabilistic similarity information. Moreover, the probabilistic similarity information refers to an information that is used for the classification of the plurality of data items 108 that are based on the likelihood of similarity between the plurality of data items 108, such as the first data item 108A up to the nth data item 108N, determined through probabilistic similarity information and regression score. In addition, the segregation of the visual representation into the plurality of clusters 122 is further used to group the similar data items from the plurality of data items 108 together in order to retrieve the data items that are similar to each other. Moreover, each cluster of the plurality of clusters 122 includes a group of data items that are similar to each other with respect to a defined number of parameters to allow retrieval during a search against one or more parameters from the defined number of parameters. The defined number of parameters may include, but are not limited to author, title, topic, domain, and the like. For example, the first cluster 122A from the plurality of clusters 122 includes the group of data items from the same domain. Similarly, the second cluster 122B from the plurality of clusters 122 includes the group of data items from the same author and the like. In accordance with an embodiment, the processor 104 is further configured to create the cluster database 120 that includes the plurality of clusters 122 based on the segregated visual representation. As a result, the cluster database 120 is used to store each cluster from the plurality of clusters 122, which includes the data items that are grouped together based on the segregated visual representation. In accordance with an embodiment, the processor 104 is configured to label each cluster, such as the first cluster 122A, the second cluster 122B, and the nth cluster 122N from the plurality of clusters 122 based on the content of the plurality of data items 108 in the corresponding cluster of the plurality of clusters 122. For example, the first cluster 122A includes the first data item 108A and the second data item 108B. Similarly, the second cluster 122B includes the data items from the plurality of data items 108 that are similar to each other.

In accordance with an embodiment, the processor 104 is further configured to determine the predetermined threshold based on natural evidence for the similar and dissimilar pairs of example data items. The natural evidence refers to characteristics of negative log odds and the probabilities that are used in hierarchical clustering algorithms, such as for the construction of a visual representation of the plurality of clusters 122, for example, the visual representation of the first cluster 122A, the second cluster 122B, up to the nth cluster 122N. Thus, the predetermined threshold is specified to perform the hierarchical clustering of the plurality of data items 108 to form the plurality of clusters 122. In accordance with an embodiment, the processor 104 is further configured to assign one or more keywords to each cluster of the plurality of clusters 122 based on the content of the plurality of data items 108 in the corresponding cluster of the plurality of clusters 122. In an implementation, the processor 104 is configured to assign a keyword, such as a title, author, owner, topic, and the like to each cluster from the plurality of clusters 122 based on the content of the plurality of data items 108 that are grouped in the corresponding cluster of the plurality of clusters 122. For example, if the cluster, such as the first cluster 122A from the plurality of clusters 122 includes the data items from the plurality of data items 108 that are written by the same author, then, in that case, the keyword “author” is assigned to the first cluster 122A. As a result, the processor 104 is configured to retrieve the group of data items from the plurality of data items 108, such as by using the one or more keywords.

In an implementation, a hierarchical clustering includes labelling a cluster label cᵢ to the ith data point and the cost of hierarchical clustering is given by the following equation (1):—

L=−ΣᵢΣⱼ[cᵢ=cⱼ]log pᵢⱼ+[cᵢ≠cⱼ]log(1−pᵢⱼ) (1)

where pᵢⱼ denotes the probability that data items (or data points) i and j are required to be clustered together. Furthermore, when two clusters, such as a cluster “C” and a cluster “D” are merged together, along with labels “1” and “2”. Therefore, the change with respect to cost is given by the following equation (2):—

$$Δ L = - {\sum }_{\frac{i}{{{c}_{i} = 1}^{}}} {\sum }_{\frac{j}{{{c}_{j} = 2}^{}}} log \frac{{p}_{ij}}{1 - {p}_{ij}} = - {\sum }_{i ∈ C} {\sum }_{j ∈ D} log \frac{{p}_{ij}}{1 - {p}_{ij}} \qquad ( 2 )$$

Moreover, by using the negative log odds

$$- log \frac{{p}_{ij}}{1 - {p}_{ij}}$$

as a “distance” dᵢⱼ between data points i and j (i.e., the distance between the data item “i” and the data item “j”), the average linkage criterium to compute the distance between the clusters from the plurality of clusters 122 are calculated through an equation (3) given below:—

$${d}_{CD} = \frac{1}{\vert C \vert \cdot \vert D \vert} {\sum }_{i ∈ C} {\sum }_{j ∈ D} {d}_{ij} = - \frac{1}{\vert C \vert \cdot \vert D \vert} {\sum }_{i ∈ C} {\sum }_{j ∈ D} log \frac{{p}_{ij}}{1 - {p}_{ij}} \qquad ( 3 )$$

In addition, the above-mentioned equation (i.e., the equation 3) is directly associated with the change in cost that is required to merge the clusters that are the cluster “C” and the cluster “D”. In an implementation, the log-odds are represented by

$$log \frac{{p}_{ij}}{1 - {p}_{ij}}$$

and the negative log odds are calculated by

$$- log \frac{{p}_{ij}}{1 - {p}_{ij}} \leq - log \frac{q}{1 - q} .$$

Moreover, the average distance between the clusters, that is the cluster “C” and the cluster “D” is calculated by

$${d}_{CD} \leq - log \frac{q}{1 - q}$$

and if the calculated distance is sufficiently small, then, in that case, the two clusters, such as the cluster “C” and the cluster “D” are merged together. However, the above-mentioned calculation is used by balanced data where

$$q = \frac{1}{2} ,$$

and the natural threshold is given by

$$log \frac{q}{1 - q} = 0 .$$

The system 100 is configured to provide an efficient, systematic, accurate, and principled hierarchical clustering of the plurality of data items 108, such as based on the probabilistic similarity information, such as by optimizing a probabilistic objective function. For example, by clustering the plurality of data items 108 by using an average linkage hierarchical clustering. The system 100 is configured to use a regression score and a hierarchical clustering algorithm that allows the system 100 to identify the similarities between the plurality of data items 108 and further group the similar data items together, resulting in a more organized and structured data set (i.e., a cluster of data items). Furthermore, the identification of the similarities between the plurality of data items 108 is performed through a trained binary classifier that is trained to identify the negative as well as positive results. In addition, the system 100 is configured to construct the visual representation that represents hierarchical relationships between the plurality of data items 108. Moreover, the system 100 is configured to segregate the visual representation into the plurality of clusters 122 based on a predetermined threshold and probabilistic similarity information that allows the system 100 to retrieve the one or more data items based on the specific parameters or characteristics in a reduced processing time and effort that is required to manually search through large data sets. As a result, the system 100 is configured to provide an intuitive way to navigate, retrieve, analyze and interpret the one or more similar data items. Moreover, the system 100 is configured to process and organize large amounts of data in order to search for the relevant information quickly and easily.

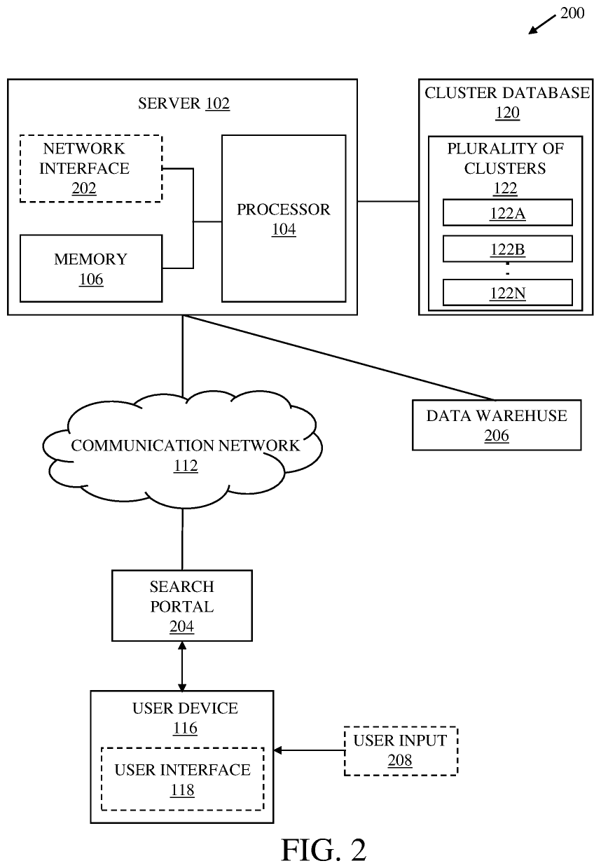

FIG. 2 is a block diagram that depicts a system for electronic processing of data items for enhanced search, in accordance with another embodiment of the present disclosure. FIG. 2 is described in conjunction with elements from FIG. 1. With reference to FIG. 2, there is shown a block diagram that depicts a system 200, which includes the server 102, the processor 104, and the memory 106. The system 200 may be used for electronic processing of data items that are for the hierarchical clustering of the plurality of data items 108, such as the first data item 108A up to the nth data item 108N.

It should be understood by one of ordinary skills in the art that the system 200 and operation of the system 200 are explained using the first data item 108A. However, the operation of the system 100 is equally applicable for the plurality of data items 108.

The server 102 includes the processor 104 and the memory 106. The server 102 may further include a network interface 202. The network interface 202 is configured to communicate with the processor 104 and the memory 106. The system 200 further includes a search portal 204 communicatively connected to the server 102 and accessible by the user device 116, via the user interface 118 rendered on the user device 116.

The system 200 further includes a cluster database 120 that is communicatively connected to the server 102. In an implementation, the cluster database 120 may be stored in the server 102. In some other implementations, the cluster database 120 may be stored outside the server 102, as shown in the system 200. The cluster database 120 may include the plurality of clusters 122, such as the first cluster 122A, the second cluster 122B, up to the nth cluster 122N. The system 200 further includes a data warehouse 206 communicatively connected to the server 102. In an implementation, the data warehouse 206 may be stored in the server 102. In some other implementations, the data warehouse 206 may be stored outside the server 102, as shown in the system 200.

The network interface 202 refers to a communication interface to enable communication of the server 102 to any other external device, such as the user device 116. Examples of the network interface 202 include, but are not limited to, a network interface card, a transceiver, and the like. Furthermore, the search portal 204 refers to a search platform to enable a user to carry out web searches, such as through a search query. In some examples, the search query may be a query that includes the one or more parameters from the defined number of parameters, such as the author's name, title, topic, images on similar topics, and the like without affecting the scope of the present disclosure. Moreover, the search query is used to identify the similar data items from the plurality of data items 108 that belongs to a specific cluster from the plurality of clusters 122 that is given by the user device 116 in the form of the user input 208. Furthermore, the data warehouse 206 refers to a large, centralized repository of data that is used for data analysis and reporting. The data warehouse 206 is designed to support efficient querying and analysis of data and is typically used to support business decision-making, data mining, and analytics.

In operation, the processor 104 is configured to receive a search query from a user, such as a user input 208 through the user device 116, and to identify one or more clusters in the cluster database 120 that are similar to the search query based on the probabilistic similarity information. In other words, the processor 104 is configured to receive a search query from a user and identify one or more clusters in the cluster database 120 that are associated with the search query based on probabilistic similarity information, as shown and described in detail in FIG. 1. As a result, the processor 104 is configured to process and visualize the plurality of data items. Thereafter, the processor 104 is configured to return the one or more data items from the identified clusters that match the search query. Moreover, the search query includes the one or more parameters from the defined number of parameters. Therefore, the system 100 allows the processor 104 to search for specific data items based on the user input 208. Firstly, the user enters the search query in order to identify the one or more data items from the plurality of data items 108. Thereafter, the processor 104 is configured to perform hierarchical clustering of the plurality of data items 108 based on the probabilistic similarity information to identify clusters that are similar to the search query. Finally, the system 100 is configured to retrieve the one or more data items that are associated with the corresponding search query, based on the one or more parameters that were included in the query. Moreover, the one or more parameters refer to a specific criterion that is used to filter and narrow down the search results, such as to obtain the one or more data items that belong to the same author, same title, and the like. As a result, the overall efficiency and accuracy of the system 100 are improved in order to retrieve the relevant information from large databases.

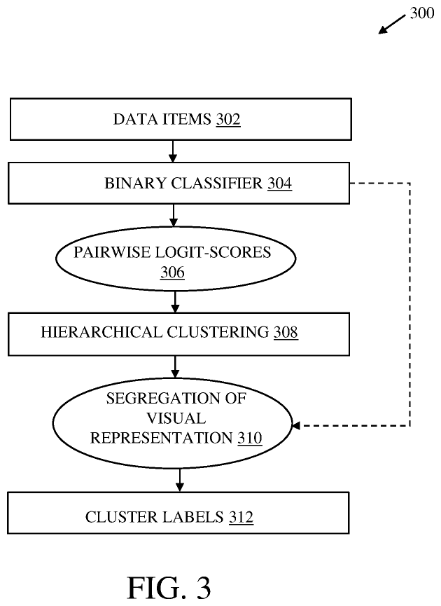

FIG. 3 is a flowchart of a method for processing a plurality of data items for enhanced search, in accordance with an embodiment of the present disclosure. FIG. 3 is described in conjunction with elements from FIGS. 1 and 2. With reference to FIG. 3, there is shown a flowchart 300 that includes a series of operations from 302-to-312. Moreover, the processor 104 (of FIG. 1) is configured to execute the flowchart 300.

At operation 302, the processor 104 is configured to receive the plurality of data items 108, such as the first data item 108A, the second data item 108B, up to the nth data item 108N from the defined database 110. Thereafter, at operation 304, the processor 104 is configured to form the pairs of the plurality of data items 108 and further computes the probability score (or a pairwise regression-score) between the formed pairs of the plurality of data items 108 through the binary classifier (i.e., a trained classifier), such as at operation 306. Moreover, the processor 104 is configured to train the binary classifier on imbalanced training data to determine the probability score for each pair of data items on a more balanced set of training pairs, such as by subsampling of negative as well as positive pairs. As a result, the binary classifier is trained via cross-entropy to predict the similarity between the plurality of data items 108. At operation 308, the processor 104 is configured to perform the hierarchical clustering of the plurality of data items 108 based on the determined regression score for each pair of data items. Furthermore, at operation 310, the processor 104 is configured to construct the visual representation that includes a hierarchical relationship among the plurality of data items 108 clustered based on the hierarchical clustering and segregate the visual representation into the plurality of clusters 122 based on a predetermined threshold and probabilistic similarity information. Finally, at operation 312, the processor 104 is configured to label each cluster of the plurality of clusters 122 based on the content of the plurality of data items 108 in the corresponding cluster of the plurality of clusters 122.

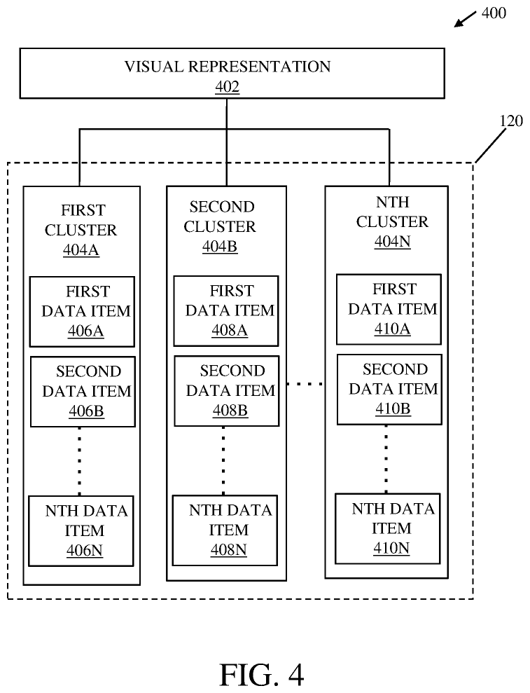

FIG. 4 is an exemplary illustration that depicts a segregation of a visual representation in order to obtain a plurality of clusters, in accordance with an embodiment of the present disclosure. FIG. 4 is explained in conjunction with elements from FIGS. 1, 2, and 3. With reference to FIG. 4, there is shown a segregation of a visual representation that depicts the hierarchical relationship among the plurality of data items 108 that are clustered based on the hierarchical clustering.

In an implementation, the processor 104 is configured to perform the hierarchical clustering of the plurality of data items 108. Firstly, the processor 104 is configured to receive the plurality of data items 108 from the database 110. Thereafter, the processor 104 is configured to pair the plurality of data items 108 based on one or more criterions, such as randomly on any other criterions without affecting the scope of the present disclosure. After that, the processor 104 is configured to determine the regression score for each pair of data items based on a probability score associated with a corresponding pair of data items in order to perform the hierarchical clustering of the plurality of data items 108. Furthermore, the processor 104 is configured to construct the visual representation that includes the hierarchical relationship among the plurality of data items 108, which is clustered based on the hierarchical clustering and segregates the visual representation into a plurality of clusters 122 based on the predetermined threshold and probabilistic similarity information. Moreover, in order to perform the hierarchical clustering of the plurality of data items 108 based on the determined regression score, the processor 104 is further configured to perform the hierarchical clustering using average linkage clustering. For example, the plurality of clusters 122, such as the first cluster 404A, the second cluster 404B, and up to the nth cluster 404N are segregated based on the predetermined threshold and the probabilistic similarity information. In addition, each cluster of the plurality of clusters 122 includes a group of data items. In an example, the first cluster 404A from the plurality of clusters 122 includes the first data item 406A, the second data item 406B, up to the nth data item 406N that are grouped together based on the predetermined threshold and the probabilistic similarity information. In another example, the second cluster 404B from the plurality of clusters 122 includes the first data item 408A, the second data item 408B, up to the nth data item 408N that are grouped together due to the similarity between each other. Moreover, the similarity between the grouped clusters from the plurality of clusters 122 is determined through a defined number of parameters that allows an efficient retrieval of information. Similarly, the nth cluster 404N from the plurality of clusters 122 includes the first data item 410A, the second data item 410B, up to the nth data item 410N that are grouped together and are similar to each other with respect to a defined number of parameters to allow retrieval during a search against one or more parameters from the defined number of parameters, such as similar author, title, domain and the like. As a result, the required group of similar data items can be retrieved from the large databases as per the requirement of the user.

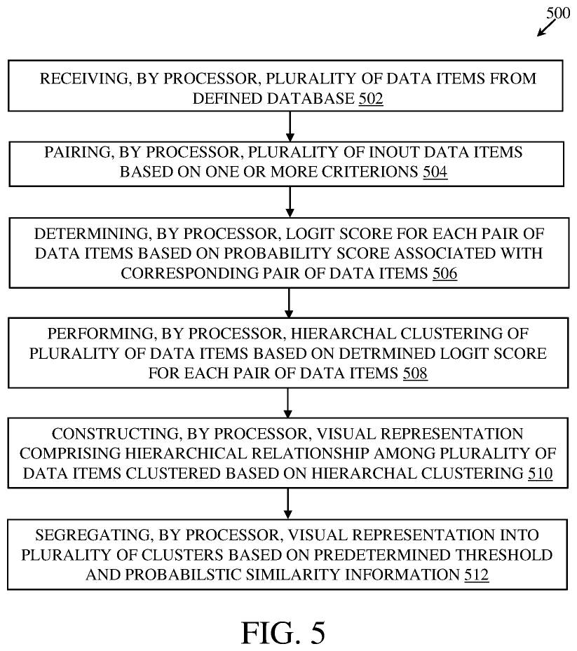

FIG. 5 is a flowchart of a method for processing one or more documents for enhanced search, in accordance with an embodiment of the present disclosure. FIG. 5 is explained in conjunction with elements from FIGS. 1, 2, 3, and 4. With reference to FIG. 5, there is shown a flowchart of a method 500 that includes steps 502-to-512. Moreover, the processor 104 (of FIG. 1) is configured to execute the method 500 for the electronic processing of the data items for enhanced search.

At step 502, the method 500 includes receiving, by the processor 104, the plurality of data items 108 from the database 110. For example, the processor 104 is configured to receive the first data item 108A from the database 110. Similarly, the processor 104 is configured to receive the second data item 108B from the database 110. After that, at step 504, the method 500 further includes pairing, by the processor 104, the plurality of data items 108 based on one or more criterions. As a result, the pairs of the plurality of data items 108 are formed to further determine the similarity or the dissimilarity between the formed pairs of the data items. Furthermore, at step 506, the method 500 further includes determining, by the processor 104, the regression score for each pair of data items based on a probability score associated with a corresponding pair of data items. The regression score refers to a statistical score that is used to measure the similarity between the pairs of data items. Moreover, the regression score is determined by calculating the log-odds ratio and further averaging the log-odds ratio across each pair of the data items.

In accordance with an embodiment, the determining of the regression score for each pair of data items based on the probability score associated with the corresponding pair of data items that includes determining, by the processor 104, a log-odds ratio for each pair of data items and averaging, by the processor 104, the log-odds ratio across each pair of data items. Moreover, the log-odds ratio for each pair of documents is defined as a natural logarithm of a ratio between the odds of the corresponding pair of documents being similar and dissimilar. In another implementation, the performing of the hierarchical clustering of the plurality of data items 108 based on the determined regression score includes merging, by the processor 104, two or more pairs of documents with one another when the average log-odds ratio of the corresponding pairs of documents is less than the predetermined threshold. In accordance with an embodiment, the method 500 includes, determining, by the processor 104, a probability score for each pair of data items by using the binary classifier. The binary classifier corresponds to a classifier that is trained to predict if the plurality of data items 108 belongs to the same cluster or not, such as by categorizing the one or more pairs of the data items as similar or dissimilar based on the probability score. In an implementation, the method 500 includes, training, by the processor 104, a binary classifier on imbalanced training data to determine the probability score for each pair of data items. In accordance with an embodiment, the method 500 includes determining, by the processor 104, the predetermined threshold based on natural evidence for the similar and dissimilar pairs of example data items. The uneven distribution of the similar and dissimilar pairs of example documents refers to an uneven number of positive and negative pairs of the example data items. However, the negative pairs denote the dissimilar pairs of the example documents and the positive pairs denote the similar pairs of the example data items. As a result, the binary classifier is trained to determine the similarity and dissimilarity between the pairs of the one or more data items that are further used to group the similar data items from the plurality of data items 108 together.

At step 508, the method 500 further includes performing, by the processor 104, the hierarchical clustering of the plurality of data items 108 based on the determined regression score for each pair of data items. In other words, the processor 104 is configured to perform the hierarchical clustering of the plurality of data items 108, such as the first data item 108A, the second data item 108B, up to the nth data item 108N based on the similarity between each of the data item from the plurality of the data items 108. For example, if the first data item 108A and the second data item 108B are similar, then, in that case, the first data item 108A and the second data item 108B are clustered together. Similarly, the data items that are similar to each other are clustered together. In an implementation, the performing of the hierarchical clustering of the plurality of data items 108 based on the determined regression score includes performing the hierarchical clustering using average linkage clustering. As a result, the average linkage clustering with the regression score is used to identify patterns and hierarchical relationships in the plurality of data items 108, which can be further used for enhanced processing of data, such as data analysis, pattern recognition, and machine learning. In accordance with an embodiment, the performing of the hierarchical clustering of the plurality of data items 108 includes merging of the two or more pairs of data items with one another when the average log-odds ratio of the corresponding pairs of data items is less than the predetermined threshold by the processor 104. Thus, the method 500 allows an efficient and accurate classification of data items from the plurality of data items 108, such as based on the similarities between the data items from the plurality of data items 108.

At step 510, the method 500 further includes constructing, by the processor 104, the visual representation comprising hierarchical relationship among the plurality of data items 108 clustered based on the hierarchical clustering. Moreover, the hierarchical relationship refers to a relationship between the plurality of the data items 108, which is represented through a hierarchical or tree-like structure. In an example, the processor 104 is configured to construct a dendrogram that includes the hierarchical relationship among the plurality of data items 108 that are clustered based on the hierarchical clustering. However, another visual representation may be constructed, which includes the hierarchical relationship among the plurality of data items 108 that are clustered based on the hierarchical clustering without affecting the scope of the present disclosure. At step 512, the method 500 further includes segregating, by the processor 104, the visual representation into the plurality of clusters 122 based on a predetermined threshold and probabilistic similarity information. Moreover, the probabilistic similarity information refers to an information that is used for the classification of the plurality of data items 108 that are based on the likelihood of similarity between the plurality of data items 108, such as the first data item 108A up to the nth data item 108N, determined through probabilistic similarity information and the regression score. In addition, the segregation of the visual representation into the plurality of clusters 122 is further used to group the similar data items from the plurality of data items 108 together in order to retrieve the data items that are similar to each other. Moreover, each cluster of the plurality of clusters 122 includes a group of data items that are similar to each other with respect to a defined number of parameters to allow retrieval during a search against one or more parameters from the defined number of parameters.

In accordance with an embodiment, the method 500 includes, labelling, by the processor 104, each cluster of the plurality of clusters based on the content of the plurality of data items 108 in the corresponding cluster of the plurality of clusters 122. In other words, the processor 104 is configured to assign one or more keywords to each cluster of the plurality of clusters 122 based on the content of the plurality of data items 108 in the corresponding cluster of the plurality of clusters 122. In an implementation, the processor 104 is configured to assign a keyword, such as a title, author, owner, topic, and the like to each cluster from the plurality of clusters 122 based on the content of the plurality of data items 108 that are grouped in the corresponding cluster of the plurality of clusters 122. For example, if the cluster, such as the first cluster 122A from the plurality of clusters 122 includes the data items from the plurality of data items 108 that are written by the same author, then, in that case, the keyword “author” is assigned to the first cluster 122A. As a result, the processor 104 is configured to retrieve the group of data items from the plurality of data items 108, such as by using the one or more keywords. In accordance with an embodiment, the method 500 includes, creating, by the processor 104, the cluster database 120 of the plurality of clusters 122 based on the segregated visual representation. As a result, the cluster database 120 is used to store each of the clusters from the plurality of clusters 122, which includes the data items that are grouped together based on the segregated visual representation.

The method 500 is used to provide an efficient, systematic, accurate and principled hierarchical clustering of the plurality of data items 108, such as based on the probabilistic similarity information, such as by optimizing a probabilistic objective function. For example, by clustering the plurality of data items 108 by using an average linkage hierarchical clustering. The method 500 uses the regression score and the hierarchical clustering algorithm that is used to identify similarities between the plurality of data items 108 and further group the similar data items together, resulting in a more organized and structured data set (i.e., a cluster of data items). Furthermore, the identification of the similarities between the plurality of data items 108 is performed through the trained binary classifier that is trained to identify the negative as well as positive results. Furthermore, the method 500 is used to construct the visual representation that represents hierarchical relationships between the plurality of data items 108 and further segregate the visual representation into clusters based on a predetermined threshold and probabilistic similarity information. Thus, the method 500 provides an efficient and accurate retrieval of the required data items based on the specific parameters or characteristics in a reduced processing time and effort that is required to manually search through large data sets. As a result, the method 500 is used to provide an intuitive way to navigate, retrieve, analyze, and interpret the one or more similar data items. Moreover, the method 500 is configured to process and organize large amounts of data in order to search for the relevant information quickly and easily.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A method for electronic processing of data items for enhanced search, the method comprising:
receiving, by a processor, a plurality of data items from a defined database;
pairing, by the processor, the plurality of data items based on one or more criterions;
determining, by the processor, a regression score for each pair of data items based on a probability score associated with a corresponding pair of data items;
performing, by the processor, a hierarchical clustering of the plurality of data items based on the determined regression score for each pair of data items;
constructing, by the processor, a visual representation comprising a hierarchical relationship among the plurality of data items clustered based on the hierarchical clustering; and
segregating, by the processor, the visual representation into a plurality of clusters based on a predetermined threshold and probabilistic similarity information,
wherein each cluster of the plurality of clusters comprises a group of data items that are similar to each other with respect to a defined number of parameters to allow retrieval during a search against one or more parameters from the defined number of parameters.

2. The method of claim 1, wherein the determining of the regression score for each pair of data items based on the probability score associated with the corresponding pair of data items comprises:
determining, by the processor, a log-odds ratio for each pair of data items; and
averaging, by the processor, the log-odds ratio across each pair of data items.

3. The method of claim 2, wherein the log-odds ratio for each pair of data items is defined as a natural logarithm of a ratio between odds of the corresponding pair of data items being similar and being dissimilar.

4. The method of claim 2, wherein the performing of the hierarchical clustering of the plurality of data items based on the determined regression score comprises merging, by the processor, two or more pairs of data items with one another when the average log-odds ratio of the corresponding pairs of data items is less than the predetermined threshold.

5. The method of claim 1, wherein the performing of the hierarchical clustering of the plurality of data items based on the determined regression score comprises performing the hierarchical clustering using average linkage clustering.

6. The method of claim 1, further comprising determining, by the processor, a probability score for each pair of data items by using a binary classifier.

7. The method of claim 1, further comprising training, by the processor, a binary classifier on imbalanced training data to determine the probability score for each pair of data items.

8. The method of claim 7, wherein the imbalanced training data comprises uneven distribution of similar and dissimilar pairs of example data items.

9. The method of claim 8, further comprising determining, by the processor, the predetermined threshold based on natural evidence for the similar and dissimilar pairs of example data items.

10. The method of claim 1, further comprising labelling, by the processor, each cluster of the plurality of clusters based on content of the plurality of data items in the corresponding cluster of the plurality of clusters.

11. The method of claim 1, further comprising creating, by the processor, a cluster database of the plurality of clusters based on the segregated visual representation.

12. The method of claim 11, further comprising:
receiving, by the processor, a search query from a user;
identifying, by the processor, one or more clusters in the cluster database that are similar to the search query based on the probabilistic similarity information; and
returning, by the processor, one or more data items from the one or more identified clusters that match the search query, wherein the search query comprises the one or more parameters from the defined number of parameters.

13. A system for electronic processing of data items for enhanced search, the system comprising:
a processor configured to:
receive a plurality of data items from a defined database;
pair the plurality of data items based on one or more criterions;
determine a regression score for each pair of data items based on a probability score associated with a corresponding pair of data items;
perform a hierarchical clustering of the plurality of data items based on the determined regression score for each pair of data items;
construct a visual representation comprising a hierarchical relationship among the plurality of data items clustered based on the hierarchical clustering; and
segregate the visual representation into a plurality of clusters based on a predetermined threshold and probabilistic similarity information,
wherein each cluster of the plurality of clusters comprises a group of data items that are similar to each other with respect to a defined number of parameters to allow retrieval during a search against one or more parameters from the defined number of parameters.

14. The system of claim 13, wherein, in order to determine the regression score for each pair of data items based on the probability score associated with the corresponding pair of data items, the processor is further configured to:
determine a log-odds ratio for each pair of data items; and
average the log-odds ratio across each pair of data items.

15. The system of claim 13, wherein, in order to perform the hierarchical clustering of the plurality of data items based on the determined regression score, the processor is further configured to perform the hierarchical clustering using average linkage clustering.

16. The system of claim 13, wherein the processor is further configured to train a binary classifier on imbalanced training data to determine the probability score for each pair of data items, and wherein the imbalanced training data comprises uneven distribution of similar and dissimilar pairs of example data items.

17. The system of claim 16, wherein the processor is further configured to determine the predetermined threshold based on natural evidence for the similar and dissimilar pairs of example data items.

18. The system of claim 13, wherein the processor is further configured to assign one or more keywords to each cluster of the plurality of clusters based on content of the plurality of data items in the corresponding cluster of the plurality of clusters.

19. The system of claim 13, wherein the processor is further configured to create a cluster database of the plurality of clusters based on the segregated visual representation.

20. The system of claim 19, wherein the processor is further configured to:
receive a search query from a user;
identify one or more clusters in the cluster database that are similar to the search query based on the probabilistic similarity information; and
return one or more data items from the one or more identified clusters that match the search query, wherein the search query comprises the one or more parameters from the defined number of parameters.
